(19) United States
(12) Patent Application Publication
(10) Pub. No.: US 2012/0064498 A1
(43) Pub. Date: Mar. 15, 2012

(54) INTERACTIVE SYSTEM AND METHOD FOR MUSICAL INSTRUMENT INSTRUCTION

(76) Inventor: John Swain, Coral Gables, FL (US)

(21) Appl. No.: 12/880,400

(22) Filed: Sep. 13, 2010

(51) Int. Cl. G09B 5/00

(52) U.S. Cl. 434/307 R

(57) ABSTRACT

An interactive computer-implemented system and method for musical instrument instruction comprising an instrument, an interface, and a computer. The instrument has one or more visual indicators, the computer is running software, and the instrument and computer are in communication through the interface. By user interaction, the instrument generates output signals that are received by the interface which processes the output signals to generate note signals. The note signals are then received by the computing system and processed by the software. The software generates feedback signals that are received by the interface. The interface processes the feedback signals and generates indicator signals that are then transmitted to one or more visual indicators on the instrument, providing the user with visual feedback of playing performance.

### TECHNICAL FIELD

The present invention relates generally to systems and methods for musical instrument instruction. More specifically, the present invention, relates to an interactive, computer-implemented system and method for musical instrument instruction. The present invention is applicable to virtually any musical instrument including, but not limited to, guitar, bass guitar, lap steel guitar, ukulele, mandolin, piano, keyboard, violin, cello, and upright bass.

### BACKGROUND OF THE INVENTION

In a typical musical instrument instruction scenario, a student and instructor meet for a face-to-face session. Generally, the instructor provides the student with a lesson book that has written lessons with a variety of examples, drills, and musical compositions corresponding to the student's relative skill level. The instructor will typically review the previous lesson with the student and provide instruction as to the next lesson, which the student has to practice and perfect on his own, in time for the next face-to-face session. As is usual, the student progresses through the lesson book lesson-by-lesson and then, upon a showing of sufficient competence, the student may move on to a more advanced lesson book.

The drawbacks of such face-to-face lessons include the relatively high cost in comparison to the time spent with the instructor, the inability to effectively develop and work on the student's weaknesses in a particular area within the time allotted for each lesson, and the relative inability to receive feedback during the student's at-home practice sessions. Often, a given lesson will be too difficult for a student to master through at-home practice and, without any further instruction, the student may become frustrated and simply stop practicing.

Other instruction methods are well known in the art, such as audio lessons on tape, CD, or digital format (i.e. mp3) or video lessons on CD-ROM, VHS, or digital format (i.e. mpeg, divx, etc. . . . ). More recently, with the development of the Internet, there are new ways of offering musical instrument instruction, such as on-line lessons that may include written music (in music notation or tablature) or depictions of how to play the particular instrument, along with accompanying written descriptions, sound clips, and/or video clips. The drawback of such online lessons is that generally such lessons provide little, if any, direct instruction but rather rely on the student to essentially teach himself the lesson presented. Additionally, the relatively mundane style and lack of instructor reinforcement associated with online lessons can quickly bore a student and lead to bad habits or failed progress.

There are also some computer-implemented musical instrument instruction and entertainment systems known in the art. For example, the Line6® GuitarPort system is a USB-based computer interface combined with specialized software that allows for some basic guitar instruction. The GuitarPort software connects to the Internet and can retrieve lessons, songs, and other programs of which the user can view and play along with. However, GuitarPort is limited in that it does not track the user's playing and accuracy. Rather, the GuitarPort system only permits the user to play over the lessons or songs without informing the user if he is playing correctly. Additionally, GuitarPort is only compatible with standard electric or acoustic-electric guitars and is not capable of providing visual feedback to the user's instrument to indicate what notes to play and/or whether the user is playing correctly.

Rock Band 3 by Harmonix is an integrated hardware/software video rhythm game that has been advertised but is not expected to be available until late 2010. The game designers advertise a specialized guitar controller having simulated strings and buttons for each string/fret combination. The instrument is purported to interface with game software that can track the user's accuracy while playing. However, this system is not expected to incorporate visual indicators on the guitar controller to indicate to the user what notes to play and/or whether the user is correctly playing each note. Moreover, Rock Band 3 does not advertise or otherwise indicate that it will provide instruction to lead to proficient instrument skills. By all appearance it will simply simulate playing for entertainment purposes.

HeroMaker by Peavey® is another integrated hardware/software video rhythm game that has been announced but not launched as of the date of the present application. The game's advertisements purport to incorporate a digital guitar controller that utilizes actual strings and frets, rather than simulated strings and buttons. The digital guitar controller is connected to game software that is designed to detect the user's playing and “score” a game or song executed by the software. However, this system also does not offer an instrument with visual indicators such that the software can send feedback information to the instrument to indicate to the user what notes to play and whether the user is playing correctly.

There are also hardware-based instrument instruction devices such as the Yamaha® EZ-AG electric guitar. The EZ-AG is a guitar having simulated strings and fret buttons as well as a built in powered speaker for audio monitoring. The device includes a selection of built-in songs and “riffs” that the user can play along. The fret buttons of the first six frets are backlight with LEDs to give visual feedback to the user, indicating where to play. However, the device is not capable of integrating with software that sends feedback information to the guitar indicating whether the student correctly played a note, played the correct note at the wrong time, played the wrong note, or simply failed to play a note at all. Additionally, the device is not capable of integrating with software that displays music notation and dynamically tracks the user's playing both on the software and on the device.

Accordingly, there is a need in the art for an interactive computer-based musical instrument teaching tool that provides visual feedback to the user directly on the instrument while tracking the user's performance through software having an easily understood graphical user interface.

### SUMMARY OF THE INVENTION

The present invention is a computer-implemented music instruction system and method comprising an electronic instrument, interfaced with a computer having software. In some embodiments, the instrument has visual indicators thereon that inform the user of the correct notes to be played and to track the user's playing accuracy. The software enables the user to play along with a lesson, song, or game while its graphical user interface depicts the correct notes and/or chords to be played. In some embodiments, the software dynamically tracks the notes actually played on the instrument and provides visual feedback of the user's performance on the graphical user interface and physically on the instrument.

In accordance with the non-limiting description herein, the present invention comprises various embodiments of an interactive computer-implemented system and method for musical instrument instruction. In some embodiments, the system comprises an instrument, an interface, and a computer. The instrument has one or more visual indicators, the computer is running software, and the instrument and computer are in communication through the interface. By user interaction, the instrument generates output signals that are received by the interface which processes the output signals to generate note signals. The note signals are then received by the computing system and processed by the software. The software generates feedback signals that are received by the interface. The interface processes the feedback signals and generates indicator signals that are then transmitted to one or more visual indicators on the instrument, providing the user with visual feedback of playing performance.

Further, in some embodiments, the method of the present invention comprises providing a user with an instrument, an interface, and a computer, the instrument having one or more visual indicators and the computer running software; establishing a connection between the instrument and the computer through the interface, whereby the instrument generates, by user interaction, one or more output signals that are received by the interface; the interface processes the one or more output signals and generates one or more note signals; the one or more note signals are received by the computer and processed by the software; the software generates one or more feedback signals that are sent from the computer to the interface; and the interface receives and processes the feedback signals and generates one or more indicator signals that are displayed on the one or more visual indicators.

Further, some embodiments of the method herein includes the steps of selecting, on a graphical user interface of the software, a desired program containing music data; displaying, on the graphical user interface, music notation corresponding to the music data of the program; initiating the program whereby the music notation scrolls across the graphical user interface as the program progresses; receiving, on the software, the note signals from the interface; comparing the note signals to the music data to determine the accuracy of the note signals and generating feedback data; and displaying the feedback data on the graphical user interface to indicate the accuracy of the note signals. Further still, the method of the present invention may include the steps of processing, on the software, the feedback data to generate feedback signals and transmitting the feedback signals to the interface and processing, on the interface, the feedback signals to generate indicator signals and transmitting the indicator signals to the one or more visual indicators on the instrument.

In some embodiments, the instrument of the present invention comprises a body, a neck, and a fretboard. The fretboard has one or more buttons, each corresponding to one or more notes. The buttons, when actuated, cause the interface to generate the one or more output signals corresponding to the one or more notes. The buttons incorporate the one or more visual indicators. Additionally, the instrument comprises one or more simulated strings wherein the strings are connected to one or more string sensors that, when actuated, cause the interface to generate the one or more output signals corresponding to one or more notes. Additional embodiments of the instrument of the present invention are described herein.

Therefore, it is the object of the present invention to provide a computer-implemented interactive musical instrument instruction system and method that assists users in learning an instrument through the use of visual and aural feedback on the instrument itself and on a graphical user-interface with which the user interacts. It is a further object of the invention to provide a multi-input, multi-output computer-implemented musical instrument system that is adapted for instruction, playing, and recording. These and other objects, features, and advantages of the present invention may be more clearly understood and appreciated from a review of ensuing detailed description of the preferred and alternate embodiments and by reference to the accompanying drawings and claims.

### BRIEF DESCRIPTION OF THE DRAWINGS

FIG. 1 is front aspect view of one embodiment of the instrument of the present invention.

FIG. 2 is a schematic of the system and method of the present invention.

FIG. 3 is diagram depicting musical notation.

FIG. 4 is an example of one aspect of the graphical user interface of the system and method of the present invention.

FIG. 5 is an example of musical notation as processed by the system and method of the present invention.

### DETAILED DESCRIPTION OF THE INVENTION

The present invention contemplates a variety of instruments that are capable of interfacing with the software described herein. It is understood that the instrument is the primary input device for the software. The instrument is capable of dynamically receiving feedback signals from the software in order to provide audio and visual feedback to the user directly on the instrument through the use of visual indicators thereon.

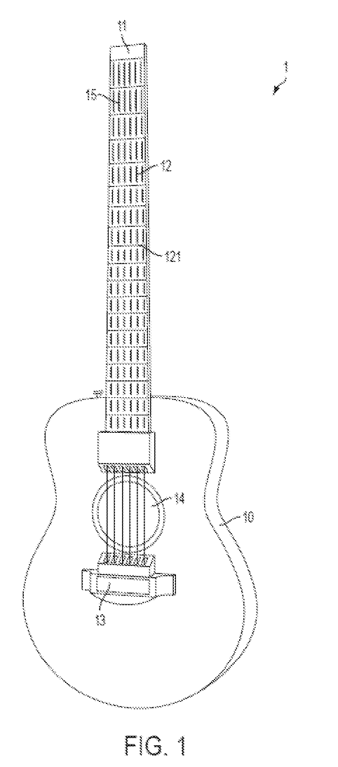

With reference to FIG. 1, one embodiment of the instrument 1 may comprise an electronic guitar or other similar plucked instrument, including but not limited to a bass guitar, ukulele, or mandolin. As shown, the guitar embodiment of the instrument 1 has all of the typical elements of a guitar including a body 10, neck 11, fretboard 12 having a plurality of frets 121, and a bridge 13. In the depicted embodiment, rather than having traditional steel or nylon strings, the instrument 1 has simulated strings 14 that extend only from the bridge 13 to the base of the fretboard 12.

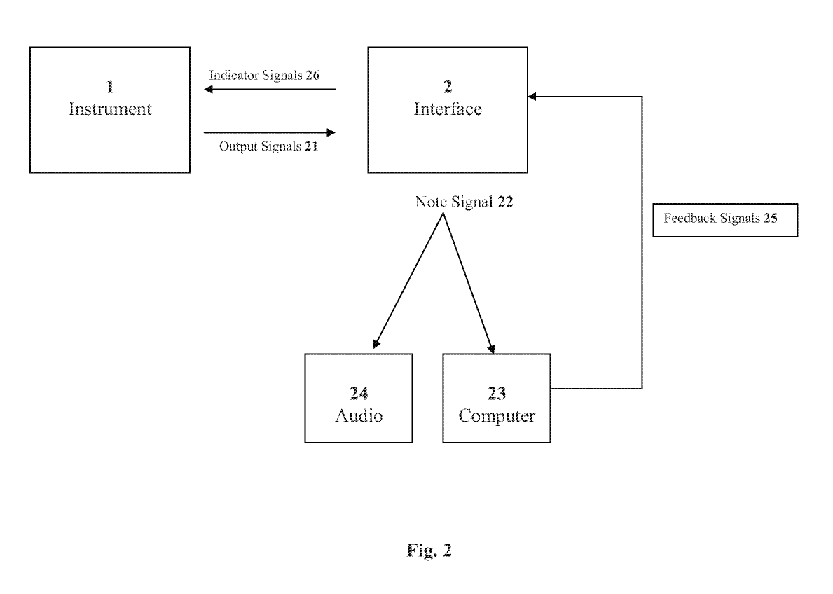

With reference to FIG. 2, in order to interact with the software, the instrument 1 is connected to an interface 2 that in turn is capable of communicating with a computer and/or an audio output audio device such as an amplifier, powered speakers, headphones, or the like. In some embodiments, the interface 2 is integrated into instrument 1; in other embodiments, the interface 2 may be an external device. Signals can be sent and/or received to and/or from the sensor and then in turn to and/or from the interface 2.

The strings 14 are connected to one or more string sensors (not shown) that detect which string or strings have been plucked and send a signal to the interface 2. In some embodiments, fretboard 12 has one or more depressible buttons 15 corresponding to each fret of each string (in FIG. 1, there are six “strings”). In some embodiments, each button 15 has a member 16 that is spring loaded such that the button 15 returns to its “undisturbed” position after being pressed and released by the user. Underneath each button 15 is a fret sensor that detects whether a corresponding button has been depressed. In some embodiments, each button 15 may have a plurality of visual indicators 17 (not shown) such as, without limitation, light-emitting diodes (LEDs) or other similar light sources disposed behind member 16. The LEDs may be of varying colors such as white, blue, red, green, orange and the like in order to provide varying visual feedback to the user directly on the fretboard 12, as described in detail below.

In some embodiments, instrument 1 may be configured as a keyboard having a plurality of keys, similar to the depressible buttons 15 of the guitar embodiment above. Underneath each key is a key sensor that detects whether a given key has been depressed. Each key may have, disposed therein, a plurality visual indicators 17 such as LEDs or other similar light sources in order to provide varying visual feedback to the user directly on the keyboard itself

The interface 2 is designed to handle several functions. In one embodiment, interface 2 is capable of processing the user's playing, i.e. the signals coming from the strings 14 and buttons 15. Typically, the user depresses one or more buttons 15 located at one or more frets and then plucks the one or more strings 14 corresponding to the fretted buttons 15. Accordingly, interface 2 is capable of receiving output signals 21 from the appropriate fret sensor(s) and string sensor(s) of instrument 1 in order to process the user's playing. If the two signals match, i.e. the correct string 14 has been plucked relative to the button 15, interface 2 generates a note signal 22. In some embodiments, a button 15 need not be depressed at all; rather, a user can simply hit an “open” string 14, which generates the appropriate note of the string's nominal pitch. In the case of the keyboard embodiment, interface 2 would receive output signals 21 from the key sensors disposed under each key.

Interface 2 is capable of processing output signals 21 to produce the note signal 22 that then can be selectively transmitted to a computer 23 and/or an audio device 24 such as an amplifier, powered speaker, headphones, or the like. Accordingly, in some embodiments, interface 2 may communicate with instrument 1 and/or computer 23 through various wired and/or wireless communications protocols. In some embodiments, interface 2 may have one or more data ports such as, for example, a universal serial bus (USB) port, firewire (IEEE 1394) port, serial port, parallel port, SCSI port and/or an audio port including but not limited to a balanced or unbalanced ¼″ or ⅛″ audio jack, an XLR audio jack, and an RCA jack. Further, interface 2 may communicate with a computer and/or audio device wirelessly, by way of, for example, Bluetooth, Wi-Fi, electronics communications network (i.e. the Internet), and other known wireless communication protocols. In the case that interface 2 is integrated into instrument 1, instrument 1 may have, on its body 10 or elsewhere, one or more of the above data ports or audio ports. In the case that interface 2 is discrete from the instrument 1, instrument 1 may communicate with interface 2 through wired or wireless communications protocols as discussed above.

Interface 2 can be connected to a computer 23 and audio device 24 simultaneously such that the interface 2 can communicate with the computer 23 while also outputting sound to the audio device 24 for monitoring. Monitoring can also be accomplished through a powered speaker integrated into instrument 1. Alternatively, the computer 23, through the software described herein, can operate as a “pass through” permitting audio to be outputted through a sound controller or other audio device in communication with the computer 23. In this scenario, interface 2 need not be connected to an external audio device 24, but rather all audio monitoring can be handled by computer 23.

Interface 2 is also capable of receiving processing information coming from the software running on computer 23. The software is capable of tracking the user's playing and providing feedback signals 25 to interface 2 and in turn, instrument 1. Feedback signals are determined by comparing the note signal 22 with music data stored with the specific program (i.e. lesson, song, or game) being executed by the software. In some embodiments, the feedback signals 25 are processed by interface 2 and interface 2 can then transmit indicator signals 26 to visual indicators 17, i.e. LEDs, on the instrument 1.

It should be understood that the computer 23 of the present invention contemplates a variety of computing systems including, but not limited to, a computer server, a personal computer, a laptop computer, a netbook computer, a tablet computer, a mobile telephone such as a smartphone, and the like. The description of the typical computer 23 is included only for illustrative purposes and should not be considered a limitation of the invention. Although this description may refer to terms commonly used in describing particular types computers 23, the described concepts apply equally to other computers 23, including systems having architectures that are dissimilar to that described.

The computer 23 includes a central processing unit (CPU) having a conventional microprocessor, random access memory (RAM) for temporary storage of information, and read only memory (ROM) for permanent storage of “read only” information. A memory controller is provided for controlling system RAM. A bus controller is provided for controlling a data bus, and an interrupt controller is provided for receiving and processing various interrupt signals from the other system components. Data storage may be provided by known non-volatile, removable media storage drives, such as a diskette drives, DVD drives, CD-ROM drives, ZIP® drives, flash drives, magneto-optical (“MO”) drives, and the like, or by non-removable storage systems like hard drives. Data and software may be exchanged with the computer 23 via removable media, such as floppy diskettes, CD-ROMs, DVDs, ZIP® disks, MO disks, flash drives and the like. The removable media is insertable into a compatible removable media storage drive, which, in turn, utilizes a controller to interface with the data bus. The non-removable storage system is part of a fixed disk drive, which utilizes a hard drive controller to interface with the data bus. User input to the computer may be provided by a number of devices. Examples include, instrument 1, a keyboard, a mouse, and a trackball, which may be connected to the data bus by an input controller. A direct memory access (DMA) controller is provided for performing direct memory access to system RAM. A visual display may be generated by the graphics subsystem of computer 23 that controls the display device attached to computer 23. The display device can be a conventional cathode ray tube (“CRT”), liquid crystal display (“LCD”), light-emitting diode (“LED”), or plasma monitor having individually addressable picture elements (“pixels”.) The pixels are arranged in a two-dimensional X-Y grid and are selectively illuminated, as directed by the graphics subsystem, for assembling an image, or a series of images (or frames) to create moving pictures.

A network interface adapter also may be included that enables the computer 23 to connect to a network via a network bus. The network, which may be a local area network (LAN), a wide area network (WAN), an electronics communication network, i.e. the Internet, or the like, may utilize general purpose communication protocols that interconnect a plurality of network devices. The computer 23 preferably is controlled and coordinated by operating system (“OS”) software, such as, for exemplary purposes only, Windows®, Mac OSX, Apple iOS, Linux, Unix, Android OS, PalmOS, Windows Mobile OS, and the like. Among other functions, the OS controls allocation of system resources and performs tasks such as process scheduling, memory management, networking, and I/O services.

The size and shape of the various components of the instrument 1 shall not be construed as limiting as it may be desired to change the relative size and shape thereof depending on the application and desired aesthetics. In the context of guitars and bass guitars, instrument 1 can be configured as a solid body, hollowbody, semi-hollowbody, or acoustic instrument. Body 10 can have a variety of configurations with respect to cutaways, body thickness, and overall geometry. Buttons 15 can comprise a variety of sizes and shapes such as elongated rectangles, crescents, circles, ovals, or the like, depending on the desired application. Neck 11 and fretboard 12 likewise can vary in shape with respect to neck profile, fretboard radius, scale length and fretboard width (i.e. nut width). Further, the fretboard 12 may vary in number of frets 121 depending on the desired application. The materials of the various components of instrument 1 need not be construed as limiting as they can be built of any material that is practicable, such as wood, carbon fiber, resins, composite materials, and the like.

The foregoing description of instrument 1 shall not be construed as limiting. In some embodiments, rather than utilizing buttons 15, the fretboard 12 itself may be a multi-touch input capable panel such as an LCD (liquid crystal display), LED (light emitting diode display), OLED (organic light emitting diode display, AMOLED (active matrix organic light emitting diode display), or the like. Accordingly, rather than requiring the user to depress hard keys, i.e. buttons 15, a multi-touch fretboard 12 would generate virtual buttons or “soft keys” located at the appropriate position along the fretboard 12 corresponding to the position of each note along the fretboard 12. Indicator signals 26 would be received and displayed on the multi-touch fretboard in similar fashion to the above described embodiments.

In the multi-touch panel configuration, the instrument may have actual strings instead of the simulated strings 14. In this configuration, the string sensor could be a passive or active pickup that is capable of sending output signals 21 to the interface 2, whereby interface 2 processes the output signals 21 to note signals 22 which are processed and tracked by the software. In this scenario, a more realistic playing scenario through the use of real strings and frets is utilized. In some embodiments, sensors inside the multi-touch panel would detect that a string is depressed at a particular fret in order to recognize which note is being played. When the string is plucked by, the user, the guitar recognizes that the note has actually been played and output signals 21 are sent to the interface 2, whereby the interface 2 processes the output signals 21 to note signals 22 which are, in turn, processed and tracked by the software. In some embodiments, instrument 1 need not be capable of displaying indicator signals 26, rather, a standard electric or acoustic instrument could be utilized, with the understanding that visual feedback will not be implemented. Additionally, if instrument 1 is a keyboard rather than a guitar, the keyboard may be configured as multi-touch panel displaying a row of “virtual” keyboard keys, i.e. “soft keys,” wherein the multi-touch panel is capable of sending output signals 21 to interface 2 and is also capable of receiving indicator signals 26 as described in accordance with the above.

In accordance with the above, the instrument 1 of the present invention is capable of dynamically interacting with customizable software that can provide instruction for the user. In some embodiments, the software is designed to provide the user with a variety of interactive lessons, songs, and/or games (i.e. programs) by dynamically displaying music notation to which the user can play along. In some embodiments, such music notation may include, without limitation, staff or stave notation, tablature, chord diagrams, and combinations thereof.

Tablature (or “tab”) is an operationally-based form of music notation indicating instrument fingering rather than the musical pitches that are represented on staff or stave notation. Because the present invention is intended to provide instruction to users with varying skill level, it may be desirable for the software to dynamically display tablature rather than staff or stave notation due to the relative ease of understanding tablature. Tablature is particularly well suited for stringed instruments such as the guitar, bass guitar, ukulele, mandolin, and violin contemplated by the present invention.

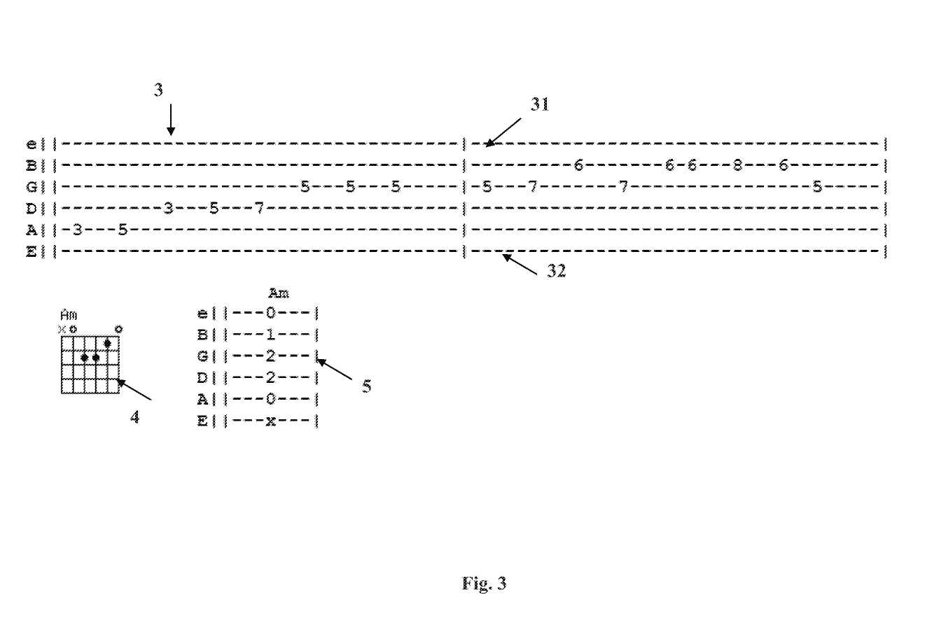

FIG. 3 shows examples of tablature 3 and chord diagrams 4 that may be utilized in some embodiments of the present invention. As shown, tablature 3 consists of a series of horizontal lines forming a pseudo-staff (or stave) similar to standard notation. Each line represents one of the instrument's strings. In this case, standard guitar tablature is represented, having a six-line staff. In some embodiments, the tablature may represent a bass guitar and thus would have four lines (in the case of a 4-string base). In this example, the top line 31 of the tablature represents the highest-pitched string of the guitar. Accordingly, by writing tablature with the lowest pitched notes on the bottom line 32 and the highest pitched notes on the top line 31, the tablature follows the same basic structure and layout of Western Standard Notation.

As noted, the software is also capable of displaying chord diagrams 4 that are useful in conjunction with or independent of tablature 3 or any other music notation format that may be desired to be implemented by the software. In the context of stringed instruments, a chord diagram depicts where the instrument player should place his/her fingers to properly fret the identified chord. In other words, it is a simplified depiction of the strings, frets, and fingers involved. Shown also is tab diagram 5 which represents the same chord as that shown in diagram 4, the A minor chord.

The software comprises a graphical user interface (GUI) that presents the user with a representation of the available programs to practice and/or play along with. The GUI is also designed to be interactive with instrument 1 such that the GUI provides visual feedback of the user's performance, including playing accuracy. Likewise, as discussed above and shown in FIG. 2, the software interacts with instrument 1 such that visual feedback corresponding to the visual feedback on the GUI is sent to the instrument.

The following is one example of how one embodiment of the system and method of the present invention would operate. The user first connects instrument 1 to a computer 23 to establish a connection between instrument 1 and the software described herein. Instrument 1 can optionally be connected to an audio device for monitoring. The user then selects a lesson, song, or game, i.e. program, through the user interface of the software and loads it. The program contains music data corresponding to the appropriate music for that program. The music data is underlying computer code containing the correct notes and chords for a given program in computer-readable format such that the software can process a comparison between the notes played by the user and the correct notes for a given program, as described in detail herein.

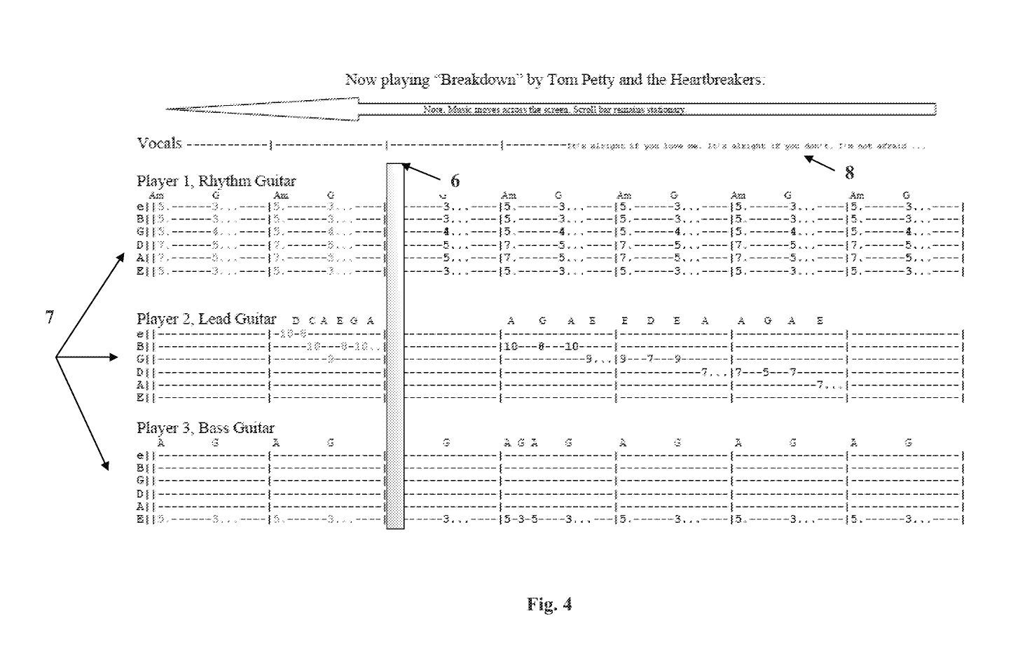

Then, the program is displayed as a series of music notations like those of FIG. 3. When the user selects “play”, or another similar command, on the GUI, the program begins. With reference to FIG. 4, a scroll bar 6 is superimposed over the notation lines 7 in order to indicate the progress of the program relative to the notation lines 7. Accordingly, the scroll bar 6 serves to highlight the note(s) and chord(s) that the user should be playing at that specific moment. The lyrics 8 to the song, if any, could be shown anywhere on user interface, provided they do not obscure the notation.

The software receives note signals 22 from interface 2 which correspond to the appropriate output signals 21 from instrument 1. The software then tracks the user's progress in real time with respect to the program, by comparing the note signals 22 to the music data stored within the program. Feedback data is generated as a result of the comparison of the note signals 22 and music data. Tracking is reported both audibly and visually: feedback signals 25 corresponding to the feedback data are sent from the software to interface 2 and then to indicator signals 26 and in turn to the visual indicators 17 on instrument 1, and the GUI depicts which notes were played correctly or incorrectly, allowing for dynamic and instantaneous feedback of the user's performance both on the instrument itself and on the GUI. In some embodiments, together with, or instead of, visual tracking, the user can receive aural feedback (e.g., a buzzer when a wrong note is played) through the audio device 24 or computer 23. The software can also record the user's progress so that the user can review his/her performance after the program is completed.

As the user plays along with the program, the notes played, whether correct or incorrect, are outputted from the instrument and/or software in low-latency real time, for monitoring. The software compares the user-played notes to the pre-stored music data for the particular program. Visually, the GUI and the instrument inform the user of this comparison by depicting which notes were played correctly or incorrectly. The accuracy of each note played can be depicted by varying the color of the relevant notes displayed on notation lines 7. In one non-limiting example, if the note is played properly it will be recorded as a green note, incorrect notes or notes played at the wrong time will be shown as red, and notes that the user simply failed to play will be shown in blue. Likewise, the relevant buttons 15 of instrument 1 will simultaneously receive visual indicators 17 corresponding to the feedback signals 25 and indicator signals 26 processed and generated to interface 2. Accordingly, both the GUI and the instrument 1 provide visual feedback to the user simultaneously. For example, a button 15 that is white indicates that it is the next correct button 15 that should be played, if that button 15 is pressed at the correct time, it will change to green, indicating it was accurately played. If the wrong note is played, or the correct notes are played at the wrong time, the respective button 15 will change to red. In turn, if the uses simply missed the button 15 or failed to play it at all, it will change to blue.

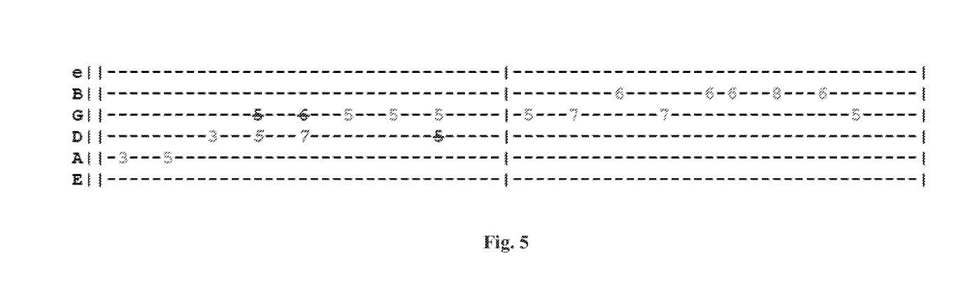

Shown in FIG. 5 is one example of how the software, method and system of the present invention provide dynamic feedback to the user as to the accuracy of his/her playing. As shown, the user played the first three notes properly, and then played the G5 string instead of the D5 string, played the G6 string instead of the D7, played the next three notes properly but also played the D5 string along with the G5 string, which, in this example, was incorrect. The rest of the song was played correctly.

In addition to musical notation, whether it be tablature, staff, or chord diagrams, the software may be capable of displaying video to assist the user with the program. For example, these videos could comprise pre-recorded clips of an instructor playing along with or providing instruction for a given program. A program may be split into various parts or sections, and accordingly, a video could be presented at the start of each section, providing practical instruction for the user before the program actually begins. Other useful applications for the combination of video, audio, and music notation multimedia will be apparent to those skilled in the art.

In some embodiments, the user can select which type of music notation he would prefer to view. Accordingly, the user could switch between tablature, staff or stave notation, and/or chord diagrams. Additionally, the software is capable of displaying tablature and staff notation simultaneously, which may be useful in learning to read music, or reinforcing certain aspects of a lesson, song, or game.

In addition to the above, the software of the present invention may also incorporate digital signal processing and digital modeling to allow the user to select a wide variety of instrument tones as desired for a given program. For example, in the context of the guitar, the software can provide a wide variety of amplifier models, effect models (e.g. overdrive, distortion, compression, reverb, delay, echo, chorus, phaser, flanger, pitch shifting, vibrato, tremolo, and the like), microphone simulations, speaker cabinet simulations, and direct-recording simulations. Accordingly, incoming note signals 22 coming from interface 2 to computer 23 can be processed by a digital signal processor and can be outputted to audio device as describe herein. This is particularly useful when the computer, through the software described herein, is operating as a “pass through” with audio outputted through sound card or other audio device in communication with the computer. Digital modeling can also be integrated into interface 2 so that interface 2 can provide a variety of tonal options directly to an external audio device 24 if desired. However, it should be understood that in the typical scenario, when an external audio device 24 is utilized, it may be desirable for interface 2 to output only an instrument level, “clean” signal so that a proper signal is sent to the audio device 24 whereby the audio device 24 handles the tonal shaping of the instrument's output.

The present invention can be configured to operate in a plurality of “modes,” depending on the desired application. For example, there can be a “single-user” version, a “multi-user” version, and a “studio” version. Single-user instruction: In the single-user mode, the system and method of the present invention provides interactive programs that could, for example, begin with basic lessons and advancing to more difficult lessons as the user progresses. For example, a virtual “instructor” would illustrate to the student how to play the proper guitar chord, both on the computer and with the visual indicators 17 on the fretboard 12 of instrument 1. The virtual instructor would play the chord and then ask the student to play it. If the student plays it correctly the virtual instructor would provide positive feedback to the student and then move on to the next chord in the lesson. If the student misplays the chord the virtual instructor would so indicate and that part of the program would be repeated until the chord is played properly. At the end of each program, the student would play all the chords learned in that lesson in an example song. The software would then determine the accuracy of playing, providing a “grade.” The user would then have the option of repeating the program and/or song until the user plays everything correctly. Additionally, in some embodiments a pre-recorded version of a complete song that is part of the program can be simultaneously played over the lesson so that the user can “play along” without missing any notes. In an alternative embodiment, the single-user version need not necessarily focus on lessons and/or instruction, but rather can simply be used for entertainment purposes, such as by playing along with a song or album. However, it should be understood that the present invention is particularly well-suited for instrument instruction and provides significant advantages over those entertainment and instruction systems known in the art.

Multi-user version instruction: The system and method of the present invention can also be designed to accommodate multiple users playing multiple instruments 1. For Example, User A could select the rhythm guitar, user B the lead guitar, and user C the bass guitar. Or, all of the users could choose the same option. Optionally, a single user could choice to play each part, i.e. rhythm guitar, lead guitar, and bass guitar in multiple passes. In multi-user mode, the GUI would be similar in design to the single user screen with each player's information scrolling simultaneously, horizontally on the screen with indicators to show which track is which.

After the program has been completed, the software will “score” the performance of each user and display an analysis of the notes properly played, missed notes and notes incorrect notes. Accordingly, the users will be able to compare their results to see who played the song more accurately and can also review the program and repeat as necessary until all users are competent at the particular program. Additionally, in some embodiments a pre-recorded version of a complete song that is part of the program can be simultaneously played over the lesson so that the users can “play along” without missing any notes.

Studio Version: A studio version can also be implemented such that it would allow the user to record and edit one or more tracks in real time, while also utilizing the visual feedback advantages of the instrument 1 and the GUI of the software. In this version, the software would allow the user or users to record each user on a separate track, play several “tracks” recording each one separately, enabling a single user to build their own song; play and record multiple tracks over prerecorded music; use a microphone as an input option on a given track giving them the ability to record vocals along with the guitar; “mix” the recording by adjusting balance, volume, and muting or deleting tracks.

In accordance with the above disclosure, it should be understood that the claimed system and method is not directed toward an abstract idea, but rather describes and claims a concrete method of musical instrument instruction, tied to particular hardware and machines including a instrument, hardware interface, and computing system.

In the foregoing description, the present invention has been described with reference to specific exemplary embodiments thereof. It will be apparent to those skilled in the art that a person understanding this invention may conceive of changes or other embodiments or variations, which utilize the principles of this invention without departing from the broader spirit and scope of the invention. The specification and drawings are, therefore, to be regarded in an illustrative rather than a restrictive sense. For instance, it is understood that the instrument 1 of the present invention need not be a guitar. Rather, any desired instrument could be used, including a bass guitar, ukulele, mandolin, violin, cello, keyboard, or piano, provided that such instrument is capable of having visual indicators integrated into the instrument at the appropriate locations, i.e. at the frets for fretted instruments, or on the keys for a keyboard or piano.

I claim:

1. A computer-implemented system for musical instrument instruction comprising:
an instrument, an interface, and a computer, said instrument having one or more visual indicators and said computer running software;
wherein said instrument and said computer are in communication through said interface;
whereby said instrument generates, by user interaction, one or more output signals that are received by said interface, said interface processes said one or more output signals and generates one or more note signals, said one or more note signals are received by said computer and processed by said software, said software generates one or more feedback signals that are sent from said computer to said interface; and said interface receives and processes said feedback signals and generates one or more indicator signals that are displayed on said one or more visual indicators.

2. The system of claim 1, wherein said one or more visual indicators are comprised of one or more light-emitting diodes of varying colors.

3. The system of claim 1, further comprising an audio device wherein said audio device is connected to said interface and whereby said note signals are received and played by said audio device.

4. The system of claim 3, wherein said audio device is selected from the group consisting of an amplifier, a speaker, headphones, a computer sound card and combinations thereof.

5. The system of claim 1, wherein said interface includes one or more data ports adapted to transmit and receive said output signals, note signals, feedback signals, and indicator signals.

6. The system of claim 5, wherein said output signals, note signals, feedback signals, and indicator signals are transmitted and received through a communications protocol selected from the group consisting of universal serial bus, firewire, serial, parallel, SCSI, Bluetooth, Wi-Fi, an electronics communications network, and combinations thereof.

7. The system of claim 5, wherein said interface communicates with said instrument through wired communication protocol selected from the group consisting of universal serial bus, firewire, serial, parallel, SCSI, and combinations thereof.

8. The system of claim 5, wherein said interface communicates with said instrument through a wireless communication protocol selected from the group consisting of Bluetooth, Wi-Fi, an electronics communications network, and combinations thereof.

9. The system of claim 1, wherein said instrument comprises a body, a neck, and a fretboard.

10. The system of claim 9, wherein said fretboard has one or more buttons, each corresponding to one or more notes.

11. The system of claim 10, wherein said one or more buttons, when actuated, cause said interface to generate said one or more output signals corresponding to said one or more notes.

12. The system of claim 11, wherein said one or more buttons incorporates said one or more visual indicators.

13. The system of claim 9, wherein said instrument further comprises one or more simulated strings wherein said strings are connected to one or more string sensors, that, when actuated, cause said interface to generate said one or more output signals corresponding to one or more notes.

14. The system of claim 9, wherein said fretboard comprises a multi-touch panel wherein said panel is capable of displaying one or more soft keys, each corresponding to one or more notes.

15. The system of claim 14, wherein said panel is selected from the group consisting of an LCD display, an LED display, an OLED display, and an AMOLED display.

16. The system of claim 15, wherein said soft keys are adapted to be displayed in two or more colors.

17. The system of claim 1, wherein said instrument comprises a keyboard having a plurality of keys wherein each said key, when actuated, cause said interface to generate said one or more output signals corresponding to one or more notes.

18. The system of claim 1, wherein said instrument comprises a keyboard having a multi-touch panel wherein said panel is capable of displaying one or more soft keys each corresponding to one or more notes.

19. The system of claim 18, wherein said panel is selected from the group consisting of an LCD display, an LED display, an OLED display, and an AMOLED display.

20. The system of claim 19, wherein said soft keys are adapted to be displayed in two or more colors.

21. A computer-implemented method of musical instruction comprising the steps of
providing a user with an instrument, an interface, and a computer, said instrument having one or more visual indicators and said computer running software;
establishing a connection between said instrument and said computer through said interface, whereby said instrument generates, by user interaction, one or more output signals that are received by said interface, said interface processes said one or more output signals and generates one or more note signals, said one or more note signals are received by said computer and processed by said software, said software generates one or more feedback signals that are sent from said computer to said interface; and said interface receives and processes said feedback signals and generates one or more indicator signals that are displayed on said one or more visual indicators.

22. The method of claim 21, further comprising the steps of
selecting, on a graphical user interface of said software, a desired program containing music data;
displaying, on said graphical user interface, music notation corresponding to said music data of said program;
initiating said program whereby said music notation scrolls across said graphical user interface as said program progresses;
receiving, on said software, said note signals from said interface;
comparing said note signals to said music data to determine the accuracy of said note signals and generating feedback data; and
displaying said feedback data on said graphical user interface to indicate the accuracy of said note signals.

23. The method of claim 22, further comprising the step of processing, on said software, said feedback data to generate feedback signals and transmitting said feedback signals to said interface.

24. The method of claim 23, further comprising the step of processing, on said interface, said feedback signals to generate indicator signals and transmitting said indicator signals to said one or more visual indicators on said instrument.

25. The system of claim 21, wherein said one or more visual indicators are comprised of one or more light-emitting diodes of varying colors.

26. The system of claim 21, further comprising an audio device wherein said audio device is connected to said interface and whereby said note signals are received and played by said audio device.

27. The system of claim 26, wherein said audio device is selected from the group consisting of an amplifier, a speaker, headphones, a computer sound card and combinations thereof.

28. The system of claim 21, wherein said interface includes one or more data ports adapted to transmit and receive said output signals, note signals, feedback signals, and indicator signals.

29. The system of claim 28, wherein said output signals, note signals, feedback signals, and indicator signals are transmitted and received through a communications protocol selected from the group consisting of universal serial bus, firewire, serial, parallel, SCSI, Bluetooth, Wi-Fi, an electronics communications network, and combinations thereof.

30. The system of claim 28, wherein said interface communicates with said instrument through wired communication protocol selected from the group consisting of universal serial bus, firewire, serial, parallel, SCSI, and combinations thereof.

31. The system of claim 28, wherein said interface communicates with said instrument through a wireless communication protocol selected from the group consisting of Bluetooth, Wi-Fi, an electronics communications network, and combinations thereof.

32. The system of claim 21, wherein said instrument comprises a body, a neck, and a fretboard.

33. The system of claim 32, wherein said fretboard has one or more buttons each corresponding to one or more notes.

34. The system of claim 33, wherein said one or more buttons, when actuated, cause said interface to generate said one or more output signals corresponding to said one or more notes.

35. The system of claim 34, wherein said one or more buttons incorporates said one or more visual indicators.

36. The system of claim 32, wherein said instrument further comprises one or more simulated strings wherein said strings are connected to one or more string sensors that, when actuated, cause said interface to generate said one or more output signals corresponding to one or more notes.

37. The system of claim 32, wherein said fretboard comprises a multi-touch panel wherein said panel is capable of displaying one or more soft keys each corresponding to one or more notes.

38. The system of claim 37 wherein said panel is selected from the group consisting of an LCD display, an LED display, an OLED display, and an AMOLED display.

39. The system of claim 38, wherein said soft keys are adapted to be displayed in two or more colors.

40. The system of claim 21, wherein said instrument comprises a keyboard having a plurality of keys wherein each key, when actuated, cause said interface to generate said one or more output signals corresponding to one or more notes.

41. The system of claim 21, wherein said instrument comprises a keyboard having a multi-touch panel wherein said panel is capable of displaying one or more soft keys each corresponding to one or more notes.

42. The system of claim 41, wherein said panel is selected from the group consisting of an LCD display, an LED display, an OLED display, and an AMOLED display.

43. The system of claim 42, wherein said soft keys are adapted to be displayed in two or more colors.
